(19) United States
(12) Patent Application Publication
(10) Pub. No.: US 2014/0328053 A1
(43) Pub. Date: Nov. 6, 2014

(54) ILLUMINATION DEVICE

(71) Applicant: Carl Zealer, Canal Winchester, OH (US)

(72) Inventor: Carl Zealer, Canal Winchester, OH (US)

(21) Appl. No.: 14/176,774

(22) Filed: Feb. 10, 2014

Related U.S. Application Data
(60) Provisional application No. 61/762,494, filed on Feb. 8, 2013.

(51) Int. Cl. F21L 4/00; F21V 23/06

(52) U.S. Cl. CPC F21L 4/00; F21V 23/06; F21Y 2101/02
USPC 362/157

(57) ABSTRACT

According to one or more aspects, an illumination device is provided. The illumination device includes a housing, a power source, a light source, a connection device, one or more covers, and an actuating member. The power source, the light source, the connection device, etc. may be disposed inside the housing (e.g., for protection from a use environment) and the connection device may electrically connect or electrically couple the power source to the light source. The cover may have an actuating member which activates the light source when depressed by toggling the connection device to connect the power source to the light source. The actuating member may be integrated with the housing or the cover and may be flush with one or more of the same.

### CROSS-REFERENCE TO RELATED APPLICATIONS

This application claims the benefit of U.S. Provisional Patent Application Ser. No. 61/762,494 (Attorney Docket No. 104542.8PRO2) entitled “ILLUMINATION DEVICE”, filed on Feb. 8, 2013. The entirety of the above-noted application is incorporated by reference herein.

### BACKGROUND

Generally, finger-worn illuminating devices or rings for the purpose of transmitting light can include a means or a way to activate and deactivate the light, such as a mechanical switch or button. Typically, activation or deactivation may be in the form of a button that extends outward, away from a bottom of a ring or other device. Because the button may extend outward from the bottom of the device, the button may break off if impacted by force. Additionally, the button in these devices may have moving parts, which increases the likelihood of a button malfunctioning.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

In accordance with one or more embodiments, an illumination device is provided. The illumination device may include a housing, a power source disposed inside the housing, a light source disposed inside the housing, a connection device disposed inside the housing. The connection device may electrically connect or electrically couple the power source to the light source. The illumination device may include a cover which is configured to attach to a bottom of the housing. The cover may have an actuating member which activates the light source when engaged, for example. The actuating member may be integrated with the cover or flush with the cover. In other words, the actuating member may be formed as a part of the cover and seamless such that the actuating member does not substantially protrude from the cover. In one or more embodiments, the illumination device may be portable or wearable. For example, the illumination device may be worn on an appendage, such as a finger, and activated when pressure is applied to the illuminating device or the actuating member of the illuminating device.

According to one or more aspects, the cover may include an actuating member, actuating portion, or portion which may be integrated in the cover associated with a side of the illumination device opposite of a finger which the device is worn. In other words, the actuating member may be on a cover which is in contact with the finger or on a cover which is not in contact with the finger, such as on an opposite side of the illumination device from where the finger is in contact with the illumination device. In one or more embodiments, a protrusion may be molded to assist in depressing the cover or facilitate in actuating the light source. Further, aspects may include adjustable or removable bands or straps to provide for replacement of broken parts or to “size” the illumination device to most any size finger or user.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example view of an illumination device worn on a finger, according to one or more embodiments.

FIG. 2 is an illustration of an example view of an illumination device worn on a finger, according to one or more embodiments.

FIG. 3 is an illustration of an example view of an illumination device worn on a finger, according to one or more embodiments.

FIG. 4 is an illustration of an example view of an illumination device worn on a finger, according to one or more embodiments.

FIG. 5 is an illustration of an example disassembled view of an illumination device, according to one or more embodiments.

FIG. 6 is an illustration of an example perspective view of an illumination device, according to one or more embodiments.

FIG. 7 is an illustration of an example view of an illumination device, according to one or more embodiments.

FIG. 8 is an illustration of an example view of an illumination device worn on a finger, according to one or more embodiments.

FIG. 9 is an illustration of an example view of an illumination device, according to one or more embodiments.

FIG. 10 is an illustration of an example disassembled view of an illumination device, according to one or more embodiments.

FIG. 11 is an illustration of an example disassembled view of an illumination device, according to one or more embodiments.

FIG. 12 is an illustration of an example view of an illumination device, according to one or more embodiments.

FIG. 13 is an illustration of an example view of an illumination device, according to one or more embodiments.

FIG. 14 is an illustration of an example view of an illumination device, according to one or more embodiments.

FIG. 15 is an illustration of an example view of an illumination device worn on a finger, according to one or more embodiments.

FIG. 16 is an illustration of an example view of an illumination device while activated, according to one or more embodiments.

FIG. 17 is an illustration of an example view of an illumination device while activated, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

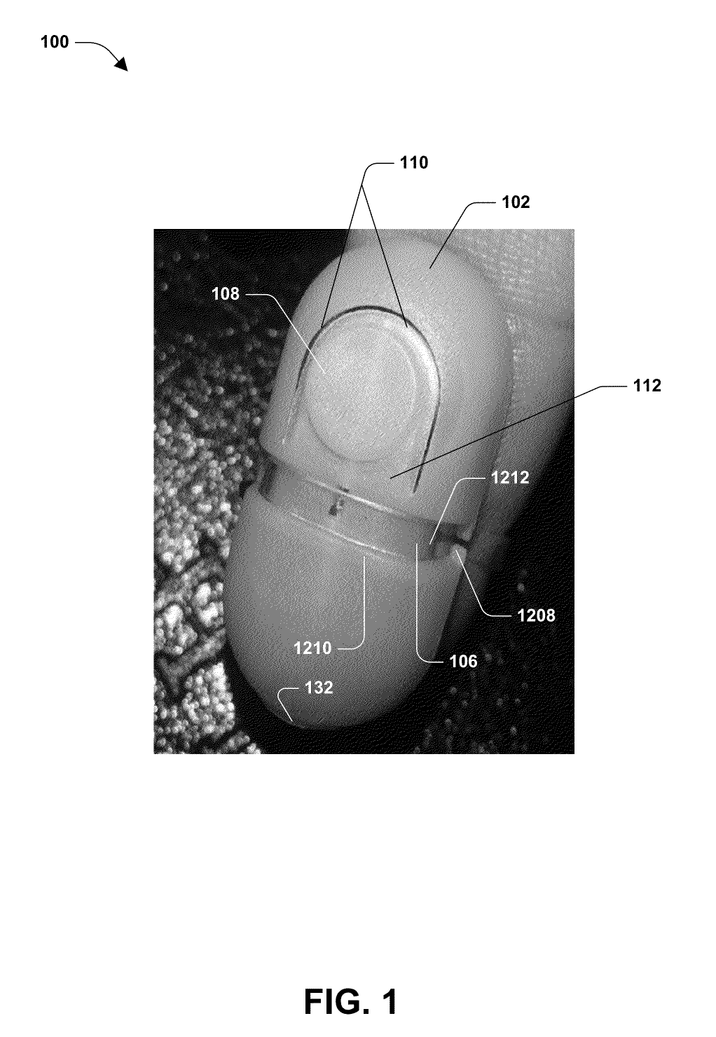

FIG. 1 is an illustration of an example view of an illumination device 100 (hereinafter “device”) worn on a finger, according to one or more embodiments. The illumination device or device 100 may include a housing 102 and a corresponding cover which fits or couples to the housing 102. The housing may be oval and/or bowl shaped such that one or more components may be housed or disposed therein. For example, a power source, a light source, a connection device, etc. may be disposed or contained within the housing 102. Accordingly, the housing 102 may offer one or more of the components protection from an external environment. As shown in FIG. 1, the housing 102 may have an integrated actuating member 108 which may be formed by creating a space associated with one or more open edges 110 and the actuating member 108 connected at a connecting edge 112. Although not shown in FIG. 1, the connection device may electrically connect or electrically couple the power source with the light source, such as when the actuating member 108 is depressed (e.g., thereby engaging the connection device to connect the power source and the light source) thereby dispersing light from the device 100. It is to be understood and appreciated that, in embodiments, a light beam need not be parallel to the finger upon which the device 100 is worn.

Further, the device 100 may include a strap 106 which may secure a body of the device or the device 100 around an appendage, such as a finger of a user, for example. The strap 106 may fit securely in a recess 1210 formed within the housing 102. In one or more embodiments, the recess 1210 may be disposed along a centerline or a center of gravity of the device 100 or the housing 102. The strap may include one or more stops 1212 which mitigate the strap 106 or the device 100 from sliding around on the user's finger. One or more slots and/or tabs 1208 may be formed or integrated with the housing such that the strap 106 may be securely fastened to the device 100 by engaging the strap within the slots 1208. In one or more embodiments, a slot may be formed on each side of the device 100. Additional slots and/or tabs 1208 may be formed as desired. It is to be appreciated that the strap 106 may be interchanged with straps (not shown) of differing diameters so as to enable a secure fit upon a wearer's finger.

In one or more embodiments, a light source 132 (hidden from view within the housing 102 of FIG. 1) may be housed within the housing 102. The user may wear the illumination device 100 such that the light source 132 is positioned at (or near) a tip of the user's finger (or thumb) or at (or near) a user's fingertips (or thumb-tip). In this way, optical illusions may be created by pressing and releasing the actuating member 108 of the housing 102 at different times. The light source may be a light emitting diode (LED) and may be capable of emitting one or more different colors. A portion of the housing 102 or cover which covers, houses, or protects the light source 132 may be made of clear, transparent, semi-transparent, translucent, or opaque material for different effects, for example. Additionally, the housing 102 may be made or constructed of materials which may be flesh colored, match a skin tone of a user, or be most any color. It is to be understood and appreciated that alternative embodiments may employ multiple LEDs or an LED(s) orientate in a different configuration than that shown in the figures. These alternative aspects are to be included within the spirit and/or scope of this disclosure and claims appended hereto.

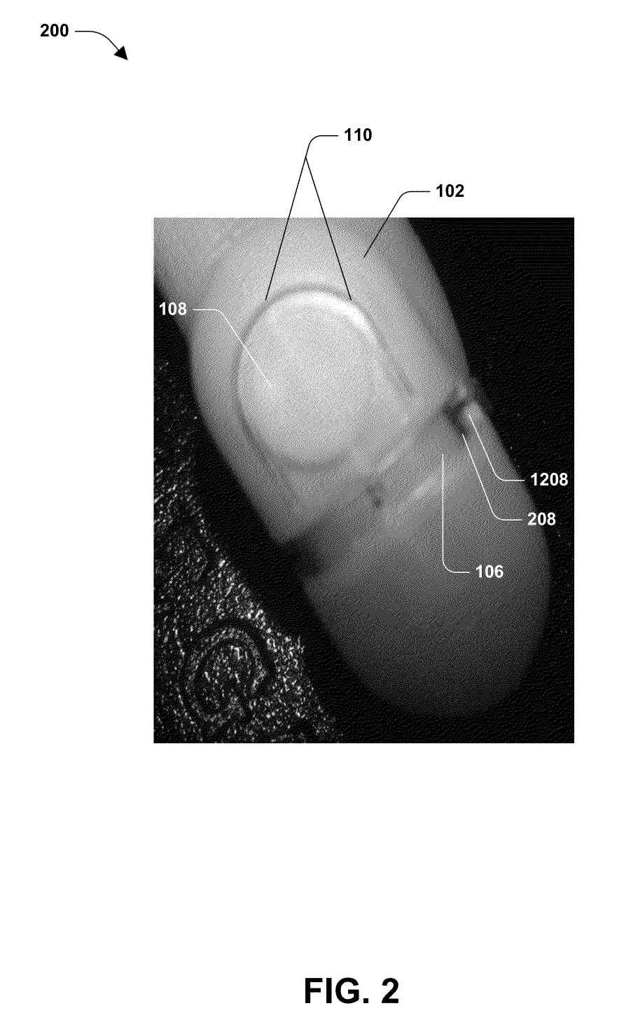

FIG. 2 is an illustration of an example view of an illumination device 200 worn on a finger, according to one or more embodiments. The device 200 may include a housing 102, an actuating member 108 integrated or formed as a part of the housing 102 via one or more open edges 110. The device may be strapped to a user's finger via strap 106. The strap 106 may be adjustable such that a user may tighten or loosen the strap. In one or more embodiments, the strap 106 may be interchangeable such that one or more different straps may be utilized for different scenarios. For example, a strap 106 may be attached or removed by weaving the strap 106 through the structure 1208 (e.g., tab) and into a slot 208 which may also be a part of the recess of the housing 102. In this way, different straps may be utilized for a same or single device 200, e.g., to accommodate different wearers or different finger diameters upon a single user.

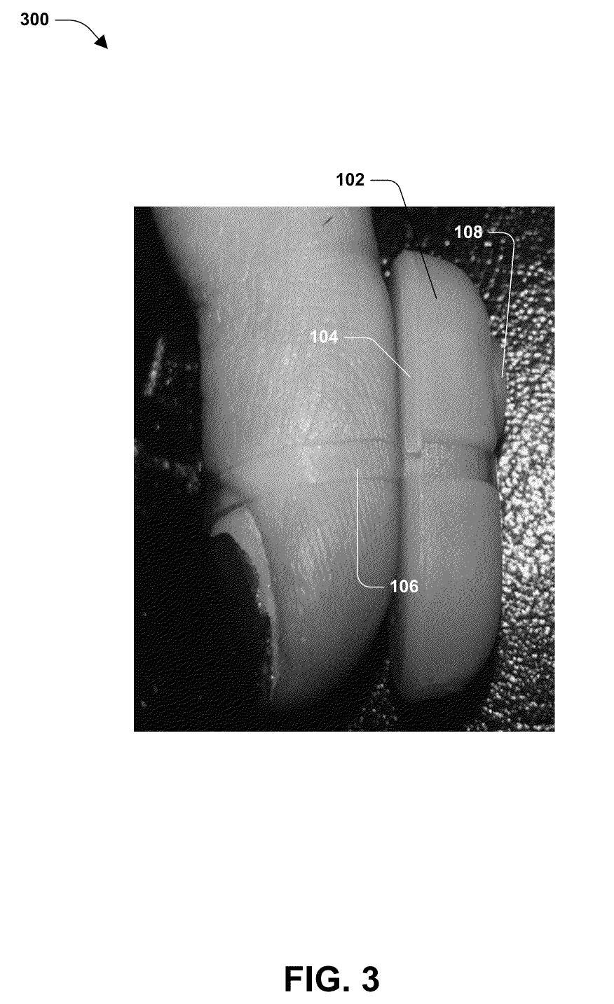

FIG. 3 is an illustration of an example view of an illumination device 300 worn on a finger, according to one or more embodiments. In FIG. 3, a side view of an illumination device 300 is shown. For example, a cover 104 may mate with a housing 102, which houses one or more internal components, such as a power source, a connection device, a light source, etc. A strap 106 may sandwich the cover 104 between the user's finger or appendage and the housing 102 with which the cover 104 mates. Further, an actuating member 108 may be formed or integrated with the housing. In one or more embodiments, the actuating member 108 may have or include one or more protrusions which may extend from the housing 102. The actuating member 108 may facilitate engaging the light source and the power source or power supply via a connection device when depressed. It will be appreciated that one or more aspects may be implemented in reverse (e.g., where the actuating member 108 is integrated into the cover 104 of the device and/or in contact with the finger of the user). For example, in FIG. 3, it can be seen the device 300 is configured such that the actuating member 108 is not in contact with the user's finger. In one or more embodiments, the strap 106 may be worn such that the same device 300 is oriented such that the actuating member 108 is in contact with the user's finger. In other embodiments, the device may be designed such that the cover has the actuating member 108 integrated therein and depression mechanisms disposed therein accordingly.

The actuating member 108 may be implemented, integrated, or positioned on the opposite side of the cover 104 or on the opposite side of the housing 102. Here, as shown, the actuating member 108 may be positioned opposite a finger of the user upon which the device 300 is worn. In one or more embodiments, the actuating member 108 may be in contact with the finger upon which the device 300 is worn or may not be in contact with the finger and be opposite of the finger. In this way, the device 300 may be associated with a variety of advantages, such as ease of use, ease of removal or sliding on/off, ease of activation, concealment associated with an illusion, etc. In aspects, the actuating member 108 may have a raised portion which facilitates ease of use or easier depression of the actuating member 108. Replacement or removable bands or straps 106 may be employed as desired.

It will be appreciated that the cover 104 and the housing 102 may be formed of transparent, semi-transparent, or opaque materials, and the one or more portions of the cover 104 or one or more portions of the housing 102 may be formed to be transparent, skin-colored, or a variety of colors. For example, a portion of a cover 104 or housing 102 near a light source may be formed to be transparent to enhance the effect of the light source while other portions of the cover 104 or the housing 102 may have a color which resembles a skin tone.

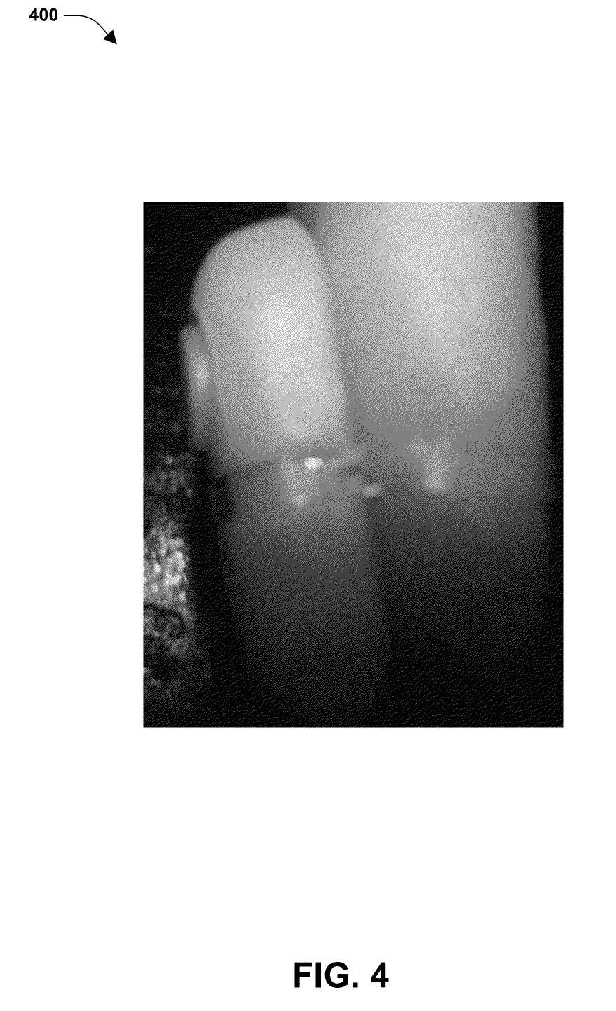

FIG. 4 is an illustration of an example view of an illumination device 400 worn on a finger, according to one or more embodiments.

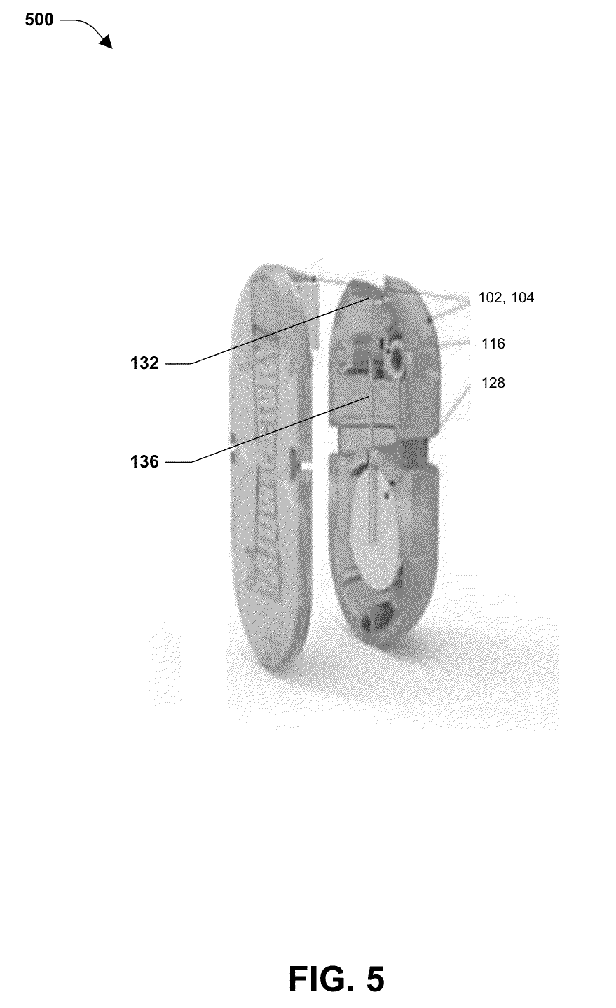

FIG. 5 is an illustration of an example disassembled view of an illumination device 500, according to one or more embodiments. The device 500 may include a housing 102 and a cover 104, one or more posts 116 which engage with one or more openings (e.g., the posts may be within the housing 102 and the openings may be formed within the cover 104 or vice versa). The device may include a power source 128 and a light source 132. These sources may be electrically connected by a connection device 136 when an actuating member (hidden from view) is depressed.

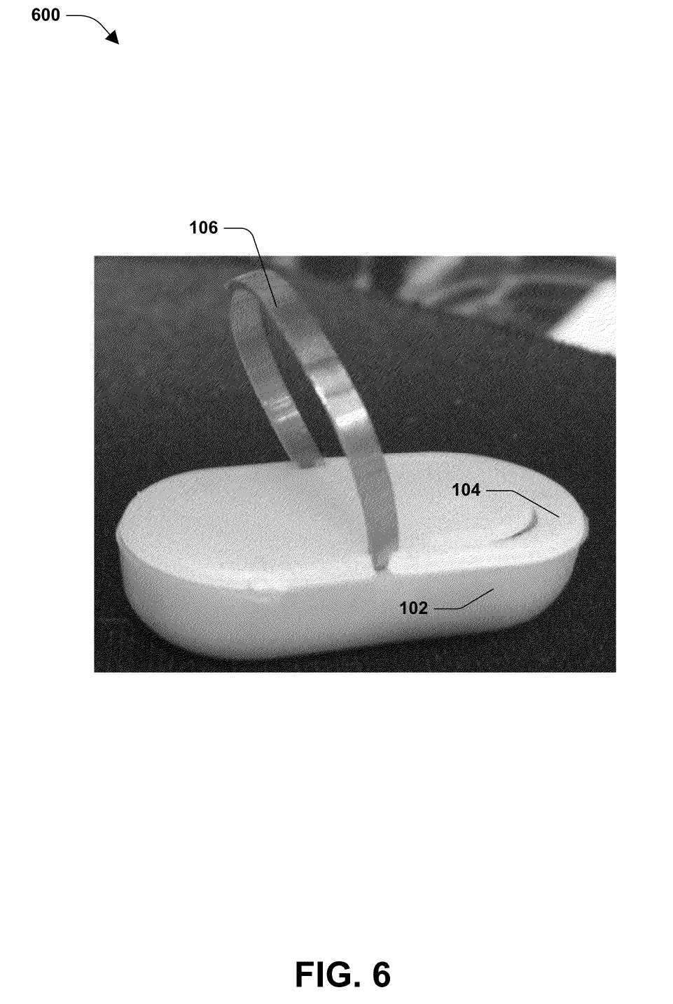

FIG. 6 is an illustration of an example perspective view of an illumination device 600, according to one or more embodiments. The illumination device 600 of FIG. 6 may include a housing 102, a cover 104, a strap 106 or a band. The housing 102 and the cover 104 may protect other components of the device 600 and may be made from most any suitable materials. For example, the housing 102 or the cover 104 may be constructed of (or otherwise molded from) or comprise material which is transparent to light (e.g., enables light to pass through the material), such as plastic, resin, epoxy, etc. It will be appreciated that other materials may be employed without departing from the spirit or scope of the disclosure described herein.

The strap 106 may be made from most any type of resilient or elastic material and may allow a user to easily or quickly utilize or remove the device 600 in a concealable manner. In one or more embodiments, the strap 106 may automatically tighten when the device is worn and pressure is applied to the cover 104 or one or more other components. In other embodiments, the strap 106 may be made from a more rigid material and may include a mechanism for adjusting the strap 106, such as an automatic retraction system. For example, a spring (not shown) inside the housing 102 may extend when no pressure is applied to cover 104 and retract when a finger is slipped into the strap 106. In this way, the device 600 and strap 106 may enable a user to quickly slip the device 600 on most any location along his or her finger. Further, as described herein, other embodiments may provide for or employ adjustable straps 106 or replacement straps 106 to enable “sizing” as appropriate.

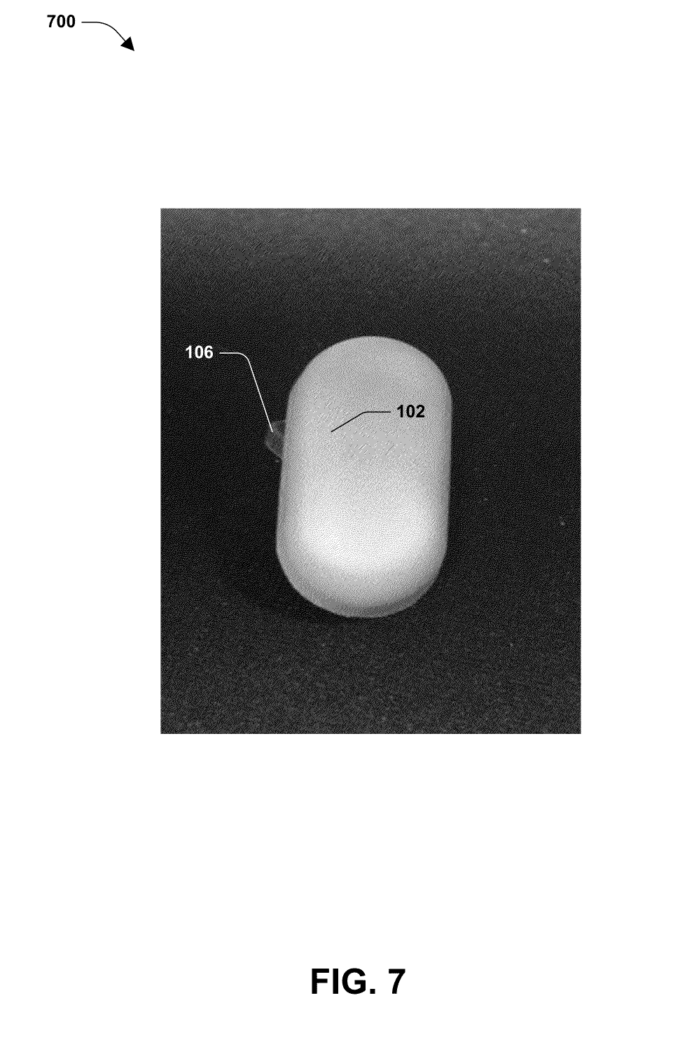

FIG. 7 is an illustration of an example view of an illumination device 700, according to one or more embodiments. In FIG. 7, the device 700 is shown with a housing 102 having an oval shape. In this example, the device 700 has a rectangular shape with rounded corners. In one or more embodiments, the shape of the housing may be formed such that the device 700 is easily concealable at an index finger of a user. For example, the housing 102 may be shaped such that the housing includes a recessed channel where a finger may reside. It will be appreciated however, the shape of the device 700 or the housing 102 may be formed to be rectangular, square, circular, etc.

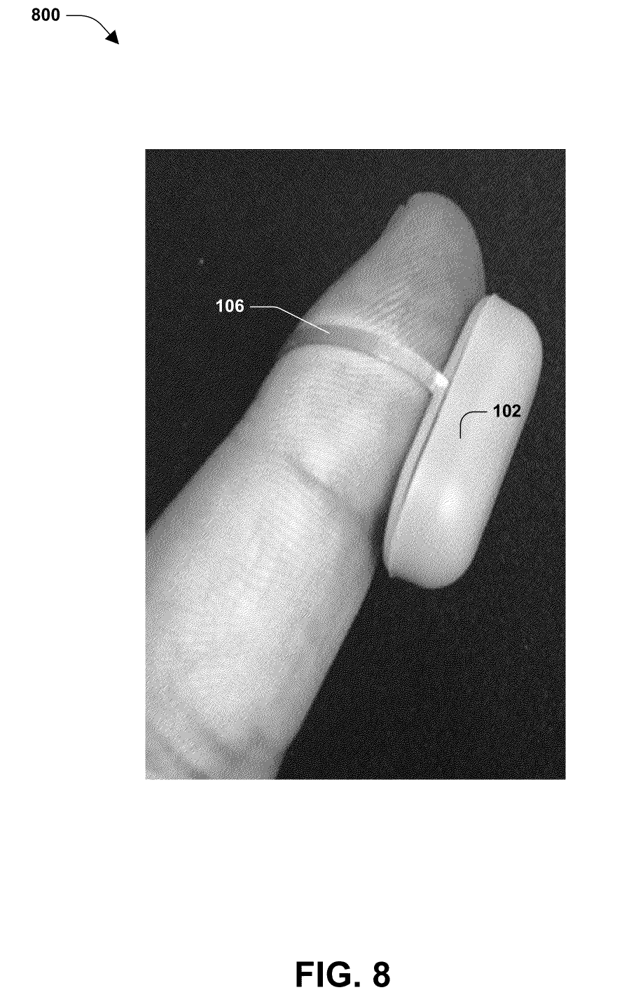

FIG. 8 is an illustration of an example view of an illumination device 800 worn on a finger, according to one or more embodiments. As shown, a user may slide and secure the device 800 of FIG. 8 by utilizing the strap 106, which is wrapped around the cover (e.g., 104 of other figures). Although not shown, when the device 800 is on the user's finger, the device 800 may be situated such that the actuating member (e.g. 108) and power source (e.g., 128) are closer to the base of the hand and the light source (e.g., 132) are located near the tip of the finger. To this end, the actuating member of the cover may be located inward, on a finger side of the device 800.

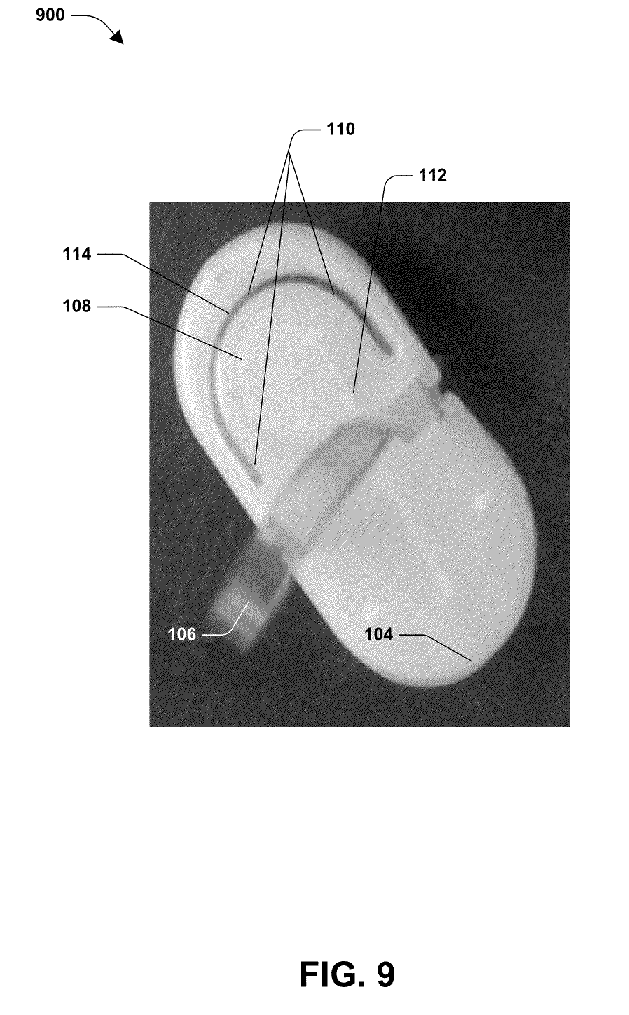

FIG. 9 is an illustration of an example view of an illumination device 900, according to one or more embodiments. In one or more embodiments, the device 900 of FIG. 9 may be configured to be worn against a finger of a user. For example, 112 may be in contact with skin or a finger of a user when the device 900 is worn. To this end, the device 900 may include a cover 104, an actuating member 108, a strap 106, one or more open edges 110, a connected edge 112, and a space 114.

The cover 104 may include the actuating member 108. When actuated or activated, the actuating member 108 may activate or enable one or more lights (not shown) within the device 900. In this example, the actuating member 108 is an integrated portion of the cover 104. For example, the actuating member 108 may be integrated with the cover 104 along a connected edge 112. Because the open edges 110 are separated from the actuating member 108 via space 114, it may be possible to depress the actuating member 108 while forming the member 108 as an integrated part or the same piece as the cover 104. In other words, the actuating member 108 may include multiple open edges 110 and a connected edge 112 that is connected to the cover 104. In this way, a space 114 may be defined in the cover 104 such that the space 114 provides a separation between the open edges 110 of the actuating member 108 and the cover 104, thereby enabling the actuating member 108 to be depressed.

The configuration of the actuating member 108 enabled the actuating member 108 to flex and activate the device 900, as will be described herein, such as when pressure is applied to the actuating member 108. Because the actuating member 108 is flush with the cover, this configuration enables activation of a light source while mitigating the possibility of breakage of the actuating member 108 (e.g., rather than employing a button which extends outward from a side of the device which may be prone to breakage if impacted by a force). Further, because the actuating member may be integrated with the cover, a number of distinct or moving parts may be mitigated, thereby enhancing the likelihood of less malfunctioning for the device 900. The configuration of the actuating member may also be on the opposite side of the device 900 where the actuating member is not in contact with the finger on which the device 900 is worn.

In one or more embodiments, the actuating member 108 has a circular U-shaped configuration. It is to be appreciated that the shape of the actuating member 108 may be rectangular, square, circular, other shaped, etc. In one or more embodiments, the actuating member may include a protrusion which facilitates activation of one or more light sources when depressed. Here, the actuating member 108 is flush with the cover 104, although other embodiments are contemplated where the actuating member 108 may protrude or be recessed from the cover 104. The actuating member 108 may facilitate ease of removal for sliding the device 900 on or off of a finger of a user, such as when the actuating member 108 is flush with the cover 104 or recessed, for example. In this way, the integrated actuating member 108 may facilitate concealment of the device 900.

In one or more embodiments, one or more features associated with the actuating member 108 may be integrated in a housing of a device, rather than the cover 104 of the device. For example, the actuating member 108 may be formed or integrated in the housing such that when that portion of the housing is depressed, a light source associated with the device will be activated. Similarly, when an actuating member 108 is formed within a housing, a space may separate the actuating member 108 from the housing and the actuating member 108 may be connected to the housing via a connected edge (e.g., similar to 112 of FIG. 9) and separated via one or more open edges (e.g., similar to 110 of FIG. 9).

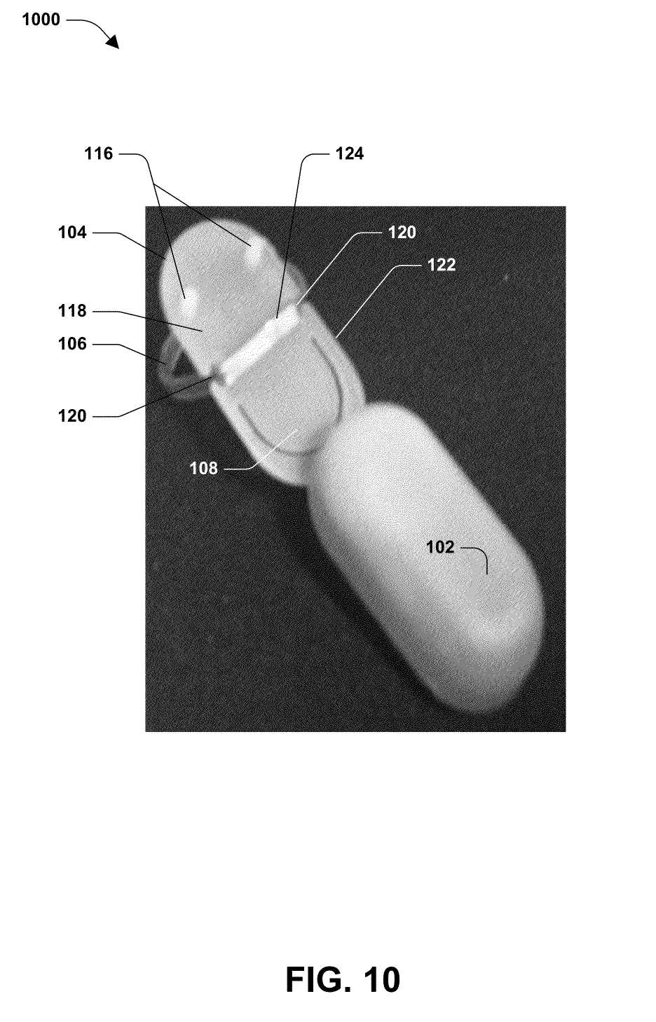

FIG. 10 is an illustration of an example disassembled view of an illumination device 1000, according to one or more embodiments. Here, in this example, the device 1000 is in a disassembled state. The cover 104 may include one or more posts 116 which extend away from and generally perpendicular to an inner surface 118 of the cover 104. One or more of the posts 116 may facilitate attachment of the cover 104 to the housing 102, which is disassembled from the cover 104 in this example.

Additionally, the cover 104 may include one or more slots 120 disposed on one or more sides 122 of the cover 104. These slots 120 may facilitate attachment of the strap 106 to the device 1000. The strap 106 may be disposed in one or more of the slots 120 and loop around the cover 104. Accordingly, it can be seen that when the cover 104 is attached to the housing 102, the strap 106 may be secured via slots 120 because the housing 102 mitigates movement of the strap 106 when engaged with the cover 104. In this way, the strap 106 may be secured around the slots 120 and sandwiched between the cover 104 and the housing 104 of the device 1000. Further, the strap 106 may extend outward from the device 1000. The strap 106 may include a stop 124 which mitigate sliding. In this way, the stop 124 of the strap 106 may mitigate the strap 106 from sliding around the user's finger.

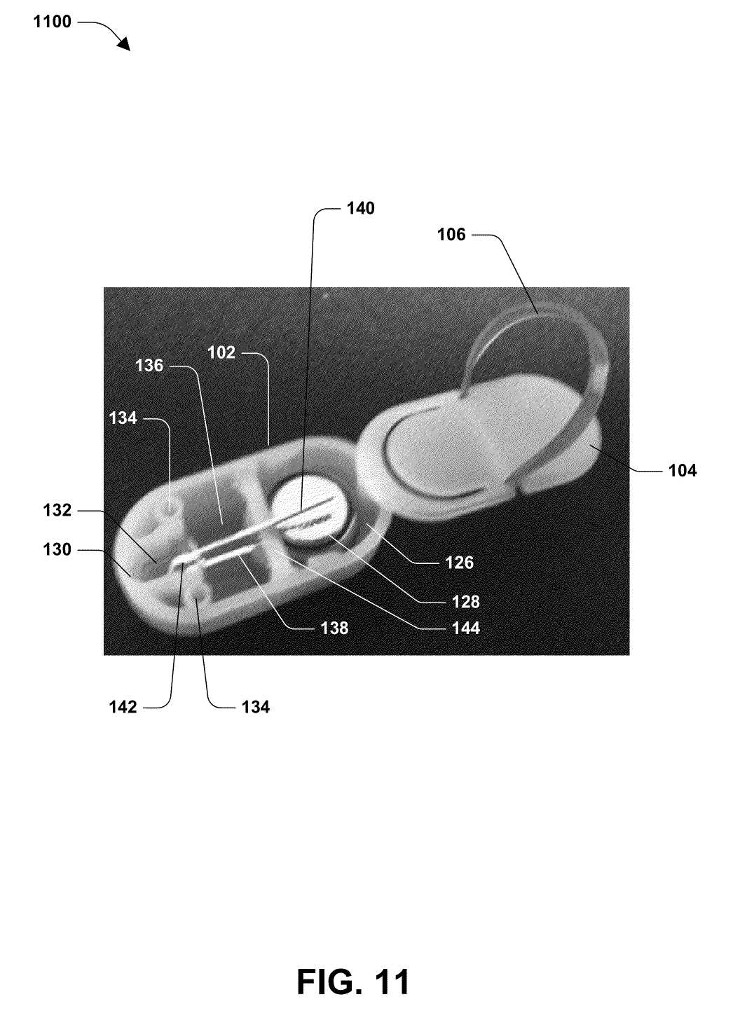

FIG. 11 is an illustration of an example disassembled view of an illumination device 1100, according to one or more embodiments. The device 1100 of FIG. 11 is in a disassembled state. In one or more embodiments, the housing 102 of the device may include a first cavity 126 which houses a power source 128 (e.g., a battery) and a second cavity 130 which houses a light source 132 (e.g., a light emitting diode or LED). The light source 132 may be implemented in a variety of colors, and may be most any desired color.

The housing 102 may include one or more openings 134 which may be configured to receive one or more posts (e.g., 116 of FIG. 10). Here, the posts from the cover 104 and the openings 134 defined by the housing 102 may align such that the posts engage the openings 134 when the cover 104 is attached to the housing 102. In one or more embodiments, the openings 134 may be disposed on either side of the second cavity 130. However, it will be appreciated that the openings 134 may be disposed at any location within the housing 102 to facilitate attachment of the cover 104.

The device 1100 may include a connection device 136 which electrically connected a power source 128 to a light source 132. The connection device 136 may be formed of any electrically conductive material which provides an electrical connection between the power source 128 and the light source 132. For example, the connection device 136 may be a conductive wire. In one or more embodiments, the connection device 136 may be a spring. For example, the connection device 136 may be a U-shaped spring having a first leg 138, a second leg 140, a connection portion 142 which connected the first leg 138 and the second leg 140. The first leg 138 may attach to an inner wall 144 adjacent to the first cavity 126 inside the housing 102. The second leg 140 may be longer in length than the first leg 138 and may extend over and past the inner wall 144 to a position adjacent to the power source 128. In this way, the connection portion 142 of the connection device 136 may connect the first leg 138, the second leg 140, and the light source 132. Accordingly, when the first leg 140 makes contact with the power source 128, the connection portion 142 provides an electrical connection to the light source 132 and to the second leg 138. Operation of the device 1100 will be described in greater detail herein.

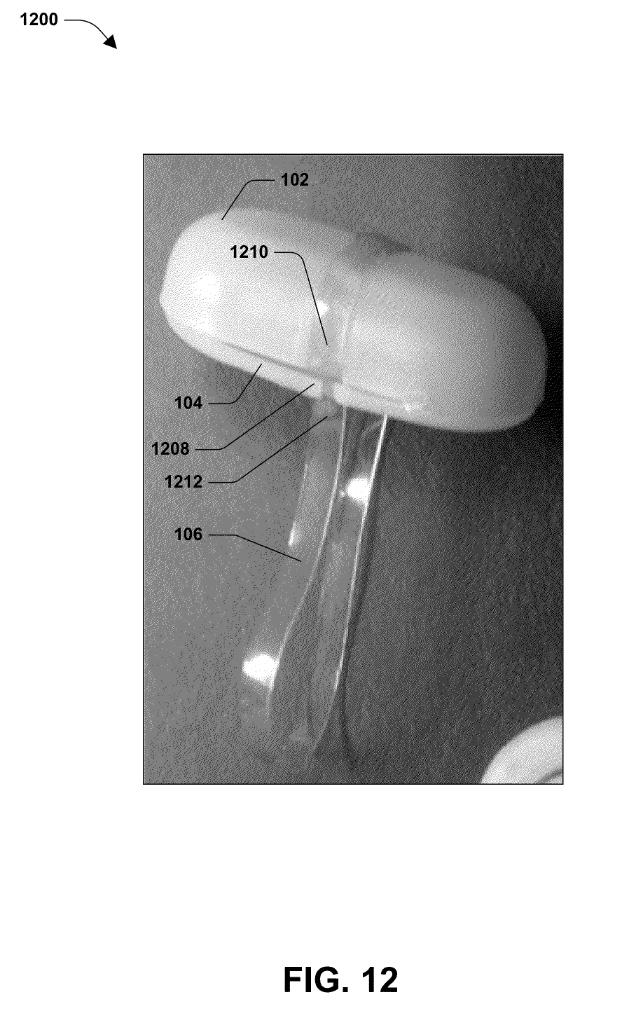

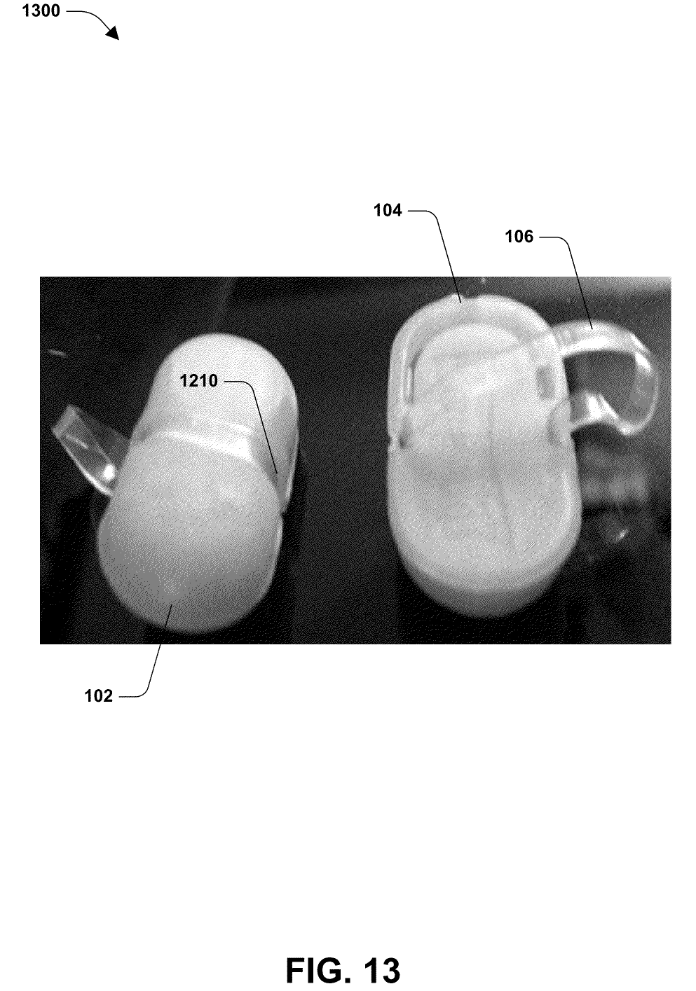

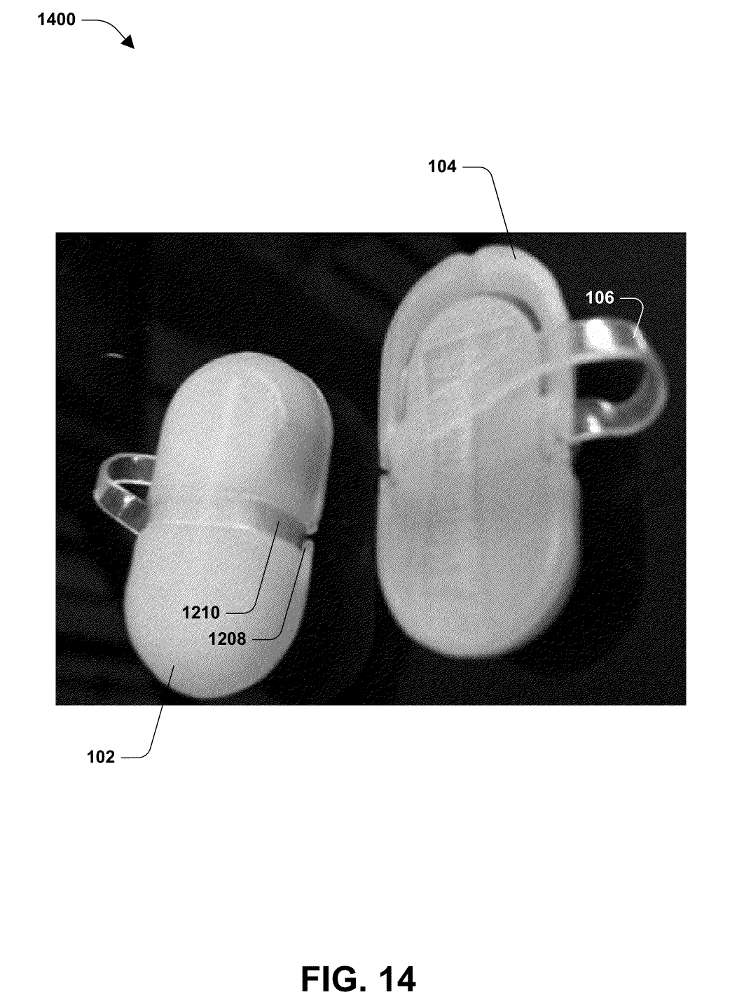

FIG. 12, FIG. 13, and FIG. 14 are illustrations of an example views of an illumination device 1200, 1300, and 1400, respectively, according to one or more embodiments. The device 1200 of FIG. 12 may include a housing 102, a cover 104, a strap 106 or a band, which enables a user to attach the device 1200 to his or her hand. The strap may be formed of any material, such as a resilient or elastic material to enable a user to easily or quickly affix the device 1200 or remove the device 1200 from his or her fingers or hands in a concealable or subtle manner. The strap 106 may comprise more rigid material which includes a means to adjust the strap 106. In one or more embodiments, a user may adjust the strap 106 to slide the device 1200 along the user's finger, for example. It will be appreciated the one or more aspects of FIG. 12 may be similar to other embodiments described herein and that alternative embodiments may be applied, such as placing or integrating an actuating member on the housing 102 rather than on the cover 104. Further, the internal configuration of other components, such as the connection device, etc. may be reversed such that the connection device faces an opposite direction or is implemented on the housing 102 rather than the cover 104 or vice versa.

It can be seen that the strap 106 of the device 1200 may engage one or more slots 1208 which are defined within the cover 104. Here, the strap 106 may loop around the outside of the housing 102 and engage the housing via a recess 1210 or track formed within the housing 102. Accordingly, when a user is wearing a device 1200, the strap 106 engages the recess 1210 of the housing 102. This mitigates the strap 106 from slipping off of the housing 102. It will be appreciated that the strap 106 may be attached to the device 1200 in most any suitable manner. Additionally, the strap 106 may include one or more stoppers 1212 which may be disposed below the cover 104 on each side of the device 1200 to mitigate sliding of the strap 106. In one or more embodiments, the slots 1208 or tabs may be configured to snap shut such that the strap 106 may not escape until the slots 1208 are opened, thereby mitigating the strap 106 from coming off of the device 1200.

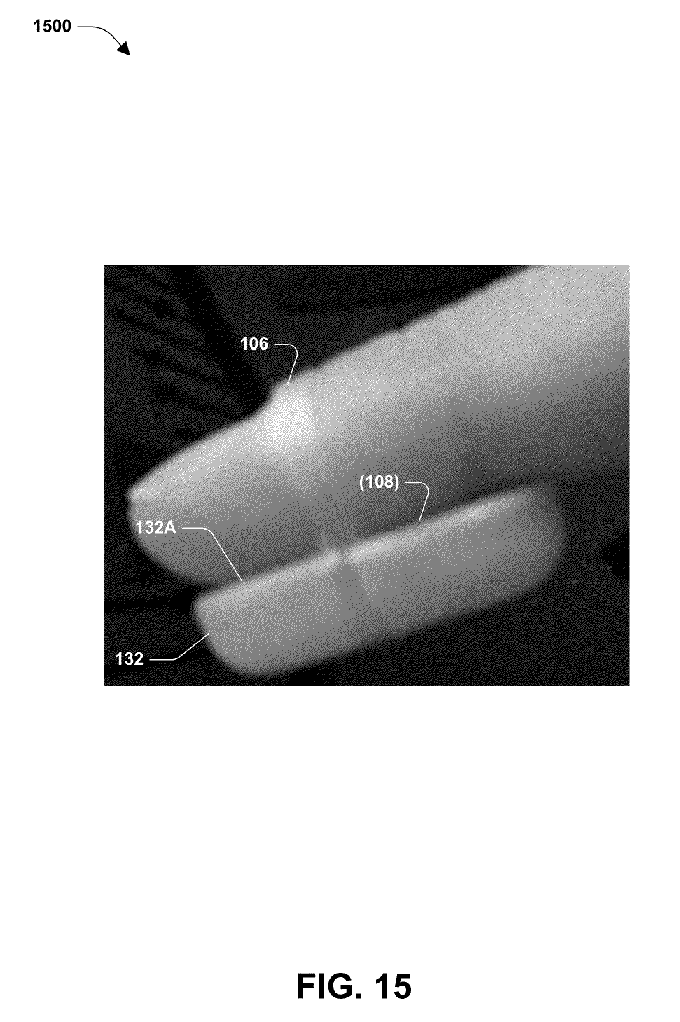

FIG. 15 is an illustration of an example view of an illumination device 1500 worn on a finger, according to one or more embodiments. As shown, a user may slide the device 1500 onto his or her finder utilizing the strap 106. When the device 1500 is on the user's finger, the device may be situated such that an actuating member (108) is located closer to a palm of the user's hand or the base of the hand. Further, a light source of the device 132 may be situated near a tip of the user's finger, as illustrated in FIG. 15. While one or more aspects illustrated or described herein disclose a light or illumination source 132 exposed near a fingertip (e.g., beam parallel to finger), it will be appreciated that according to other aspects the illumination source 132 may light up a user's fingertip (e.g., the light source may be placed at 132A). For example, the light may be projected into a user's fingertip thereby illuminating the fingertip (e.g., or portion of finger) upon activation. These and other variations are to be included within the scope of this disclosure and claims appended hereto.

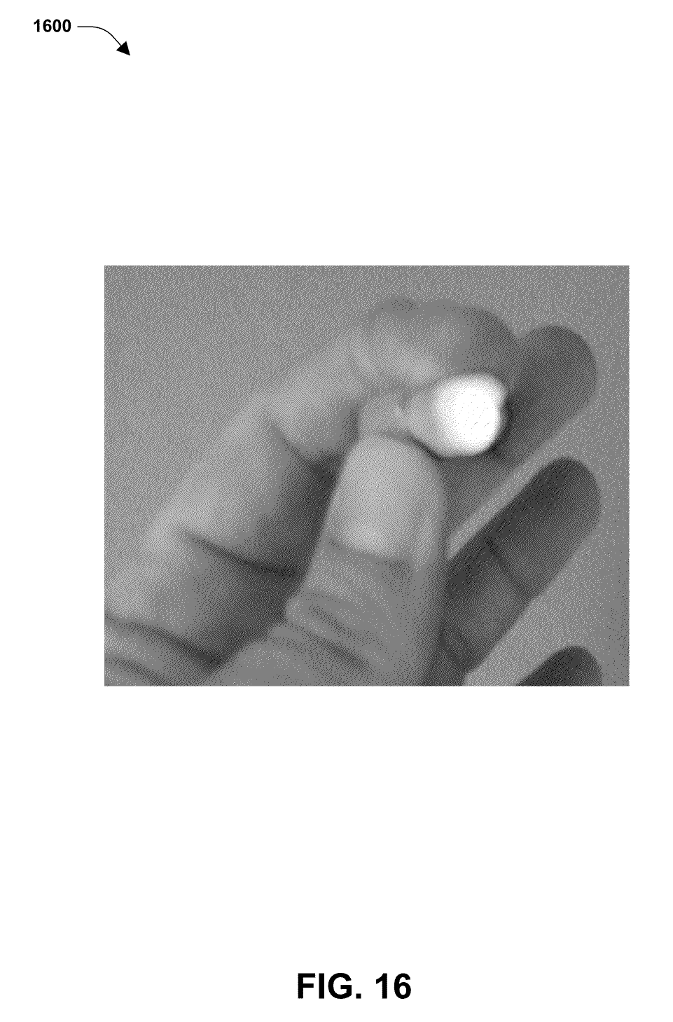

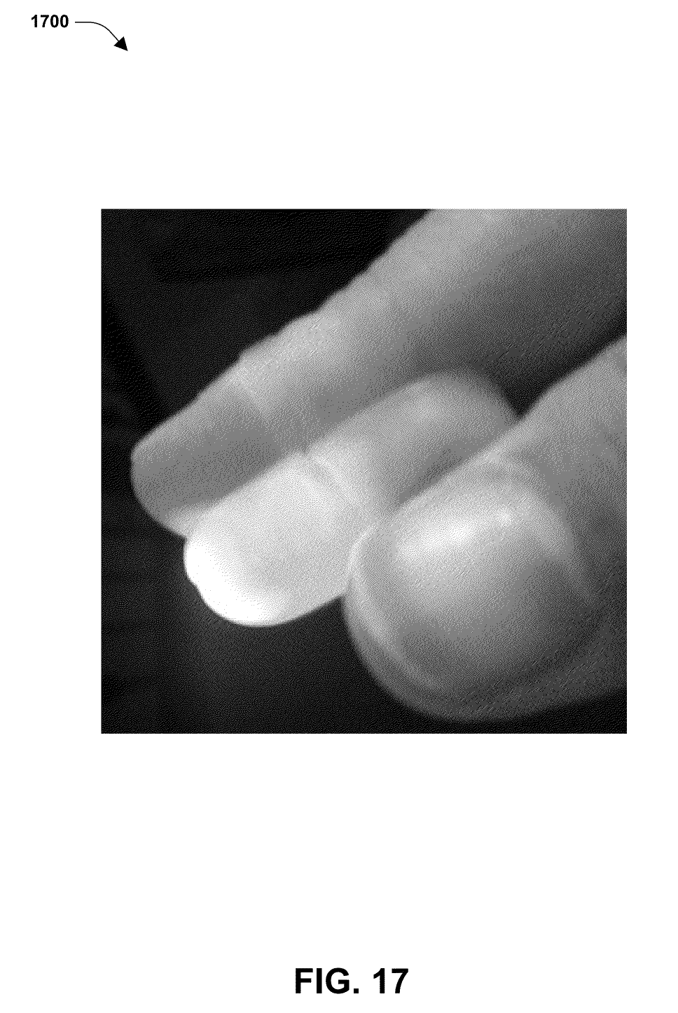

FIG. 16 is an illustration of an example view of an illumination device 1600 while activated, according to one or more embodiments. FIG. 17 is an illustration of an example view of an illumination device 1700 while activated, according to one or more embodiments. FIG. 16 and FIG. 17 will be described with reference to or utilizing reference numbers from one or more of the figures herein, such as FIG. 11, for example.

When a user slides the device 1600 on his/her finger, the user may applies pressure with their thumb and/or forefinger or index finger to the housing 102 adjacent to the actuating member 108. Effectively, this pressure flexes the actuating member 108 against the first leg 140 of the spring 136, which then contacts the power source 128. Accordingly, the contact provides an electrical connection between the power source 128 and the light source 132 thereby illuminating the light source 132. When the user releases the pressure on the actuating member 108, the connection device 136 biases the actuating member 108 away from the power source 128. Thus, the light source 132 is deactivated. It is to be appreciated that the actuating member 108 has self-biasing characteristics and biases itself away from the power source 128 when pressure is removed. Thus, the connection device 136 need not have biasing capabilities.

In one or more embodiments, a user may utilize an illumination device for the purpose of creating an illusion of “throwing” or transferring light from a first point to second point. For example, the device may be used to create the illusion of throwing a light between the hands of a user. To accomplish such an illusion, the user places a device on a finger of each hand (e.g., a first device on a left hand and a second device on a right hand) and applies pressure, with the thumb (see FIG. 16 and FIG. 17) to one device at a time (e.g., alternating between the first device and the second device). The user then concurrently performs a throwing motion with the hand having a device which is activated and performs a catching motion with the hand having a device which is not activated. At a precise moment, the user may release pressure from activated device and apply pressure to the non-activated or deactivated device, thereby creating the illusion that light was thrown from one hand to the other hand.

Different combination of colors may be utilized for the light source 132 or color of the cover 104 or the housing 102. For example, to further facilitate the illusion that the user is throwing light from hand to hand, the color of device, housing 102, or cover 104 may be a color that closely matches the skin pigment of the user. It is to be appreciated, however, the color may be most any color, including transparent. It should be noted that the color should allow for the transfer of light through the housing 102. Additionally, it is to be understood that the light source may employ a variety of colors. For example, LEDs in white, green, red, etc. may be employed in alternative aspects. As another example, the device may be used as a hands free illumination device for the purpose of illuminating a low light environment. Thus, in this example the device may be used to view objects, read, or a flashlight, etc.

According to one or more aspects, a system for providing illumination is provided, including a housing, an actuating member, a power source disposed within the housing, a light source disposed within the housing, a connection device disposed within the housing, and a cover which mates with the housing. The connection device may electrically connect the power source and the light source when the actuating member is depressed, such as when an external pressure is applied. The actuating member may be disposed opposite a finger upon which the system is worn.

In one or more embodiments, the housing may be oval shaped, the actuating member may formed as an integrated portion of the housing, the actuating member may be formed as an integrated portion of the cover, the power source may be a battery, the light source may be a light emitting diode (LED), the cover may be shaped according to a contour of a finger (e.g., curved), a portion of the housing or a portion of the cover associated with the light source may be transparent or semi-transparent, or the cover or the housing may have a skin tone color.

According to one or more aspects, an illumination device is provided, including a housing comprising an actuated member formed as an integrated portion within the housing, a power source disposed within the housing, a light source disposed within the housing, a connection device disposed within the housing, and a cover which mates with the housing. The connection device may electrically connect the power source and the light source when the actuating member is depressed.

In one or more embodiments, the actuating member may have one or more open edges which are not connected to the housing and a connected edge integrally attached to the housing. The actuating member may flex toward the connection device disposed inside the housing when an external pressure is applied to the actuating member. In this way the power source may be electrically connected to the light source, thereby illuminating the light source. The connection device may be a U-shaped spring which biases the actuating member away from the power source when an external pressure is removed from the actuating member or when no external pressure is being applied to the actuating member. The illumination device may include a strap looped around the housing or the cover for attachment of the illumination device to one or more appendages. The actuating member may include a raised portion.

According to one or more aspects, an illumination device is provided, including a housing, a cover which mates with the housing, wherein the cover comprises an actuated member formed as an integrated portion within the cover, a power source disposed within the housing, a light source disposed within the housing, and a connection device disposed within the housing. The connection device may electrically connect the power source and the light source when the actuating member is depressed. The illumination device may include a strap looped around the housing or the cover for attachment of the illumination device to one or more appendages. The actuating member may include a raised portion, a molded portion, or a raised molded portion, etc.

In one or more embodiments, the cover may be attached to a surface of the housing and the cover may have an actuating member to activate a light source. The actuating member may be flush or substantially flush with a surface of the cover or a surface of the housing. A strap may facilitate attachment of the illuminating device to a finger or thumb, for example.

The actuating member may be positioned opposite a surface of a finger upon which the device is positioned or to be positioned. In one or more embodiments, the actuating member may include a raised portion, a molded portion, or a raised molded portion. The actuating member may flex toward a connection device disposed inside the housing when an external pressure is applied to the actuating member, thereby electrically connecting the power source to the light source to illuminate the light source. The connection device may be a U-shaped spring that biases the actuating member away from the power source when the external pressure is removed from the actuating member. The device or illuminating device may include a removable and sizable strap to facilitate the attachment of the illumination device to a human finger or thumb.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for providing illumination, comprising:
a housing;
an actuating member disposed opposite a finger upon which the system is worn;
a power source disposed within the housing;
a light source disposed within the housing;
a connection device disposed within the housing, wherein the connection device electrically connects the power source and the light source when the actuating member is depressed; and
a cover which mates with the housing.

2. The system of claim 1, wherein the housing is oval shaped.

3. The system of claim 1, wherein the actuating member is formed as an integrated portion of the housing.

4. The system of claim 1, wherein the actuating member is formed as an integrated portion of the cover.

5. The system of claim 1, wherein the power source is a battery.

6. The system of claim 1, wherein the light source is a light emitting diode (LED).

7. The system of claim 1, wherein the cover is shaped according to a contour of a finger.

8. The system of claim 1, wherein a portion of the housing or a portion of the cover associated with the light source is transparent or semi-transparent.

9. The system of claim 1, wherein the cover has a skin tone color.

10. The system of claim 1, wherein the housing has a skin tone color.

11. An illumination device, comprising:
a housing comprising an actuated member formed as an integrated portion within the housing;
a power source disposed within the housing;
a light source disposed within the housing;
a connection device disposed within the housing, wherein the connection device electrically connects the power source and the light source when the actuating member is depressed; and
a cover which mates with the housing.

12. The device of claim 11, wherein the actuating member has one or more open edges which are not connected to the housing and a connected edge integrally attached to the housing.

13. The device of claim 11, wherein the actuating member flexes toward the connection device disposed inside the housing when an external pressure is applied to the actuating member, thereby electrically connecting the power source to the light source and illuminating the light source.

14. The device of claim 11, wherein the connection device is a U-shaped spring which biases the actuating member away from the power source when an external pressure is removed from the actuating member or when no external pressure is being applied to the actuating member.

15. The device of claim 11, comprising a strap looped around the housing or the cover for attachment of the illumination device to one or more appendages.

16. The device of claim 11, wherein the actuating member comprises a raised portion.

17. An illumination device, comprising:
a housing;
a cover which mates with the housing, wherein the cover comprises an actuated member formed as an integrated portion within the cover;
a power source disposed within the housing;
a light source disposed within the housing; and
a connection device disposed within the housing, wherein the connection device electrically connects the power source and the light source when the actuating member is depressed.

18. The device of claim 17, comprising a strap looped around the housing or the cover for attachment of the illumination device to one or more appendages.

19. The device of claim 17, wherein the actuating member comprises a raised portion.

20. The device of claim 17, wherein the actuating member comprises a molded portion.
